(19) United States
(12) Patent Application Publication
(10) Pub. No.: US 2026/0313555 A1
(43) Pub. Date: Oct. 8, 2026

(54) LOW POWER-WAKEUP SIGNAL SUBCARRIER SPACING AND ACTIVE DOWNLINK BANDWIDTH PART ALIGNMENT

(71) Applicant: QUALCOMM Incorporated, San Diego, CA (US)

(72) Inventors: Jung Ho RYU, Englewood Cliffs, NJ (US); Kazuki TAKEDA, Minato-ku (JP)

(21) Appl. No.: 19/634,993

(22) Filed: Mar. 31, 2026

Related U.S. Application Data
(60) Provisional application No. 63/784,661, filed on Apr. 7, 2025.

(51) Int. Cl. H04W 52/02; H04L 27/26; H04W 76/28

(52) U.S. Cl. CPC H04W 52/0235; H04L 27/26025; H04W 76/28

(57) ABSTRACT

This disclosure provides methods, components, devices and systems for low power-wakeup signal (LP-WUS) subcarrier spacing (SCS) and active downlink bandwidth part (BWP) alignment. For example, a user equipment (UE) may receive first information that configures a set of downlink BWPs for the UE, each downlink BWP in the set of downlink BWPs being associated with a different SCS. The UE may receive second information that identifies a set of LP-WUS configurations for the UE, each LP-WUS configuration in the set of LP-WUS configurations identifying LP-WUS monitoring occasions for the UE to monitor for an LP-WUS, wherein an SCS of the LP-WUS comprises a same SCS as an active downlink BWP from the set of downlink BWPs. The UE may monitor the LP-WUS monitoring occasions according to one or more of the set of LP-WUS configurations and a configuration of the active downlink BWP.

### CROSS REFERENCE

The present Application for Patent claims benefit of U.S. Provisional Patent Application No. 63/784,661 by RYU et al., entitled “LOW POWER-WAKEUP SIGNAL SUBCARRIER SPACING AND ACTIVE DOWNLINK BANDWIDTH PART ALIGNMENT,” filed Apr. 7, 2025, which is assigned to the assignee hereof, and which is expressly incorporated by reference herein in its entirety.

### TECHNICAL FIELD

This disclosure relates generally to wireless communication, and more specifically to systems, devices, methods, and techniques associated with low power-wakeup signal subcarrier spacing and active downlink bandwidth part alignment.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipment (UEs)), and others. Such devices may communicate with one another using a variety of protocols (such as radio access technologies (RATs)), including those of cellular-based systems such as fourth generation (4G) systems (such as Long-Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving first information that configures a set of downlink bandwidth parts (BWPs) for the UE, each downlink BWP in the set of downlink BWPs being associated with a different subcarrier spacing (SCS), receiving second information that identifies a set of low power-wakeup signal (LP-WUS) configurations for the UE, each LP-WUS configuration in the set of LP-WUS configurations identifying LP-WUS monitoring occasions for the UE to monitor for an LP-WUS, where an SCS of the LP-WUS includes a same SCS as an active downlink BWP from the set of downlink BWPs, and monitoring the LP-WUS monitoring occasions according to one or more of the set of LP-WUS configurations and a configuration of the active downlink BWP.

A UE for wireless communications is described. The UE may include a processing system that includes processor circuitry and memory circuitry that stores code. The processing system may be configured to cause the UE to receive first information that configures a set of downlink BWPs for the UE, each downlink BWP in the set of downlink BWPs being associated with a different SCS, receive second information that identifies a set of LP-WUS configurations for the UE, each LP-WUS configuration in the set of LP-WUS configurations identifying LP-WUS monitoring occasions for the UE to monitor for an LP-WUS, where an SCS of the LP-WUS includes a same SCS as an active downlink BWP from the set of downlink BWPs, and monitor the LP-WUS monitoring occasions according to one or more of the set of LP-WUS configurations and a configuration of the active downlink BWP.

Another UE for wireless communications is described. The UE may include means for receiving first information that configures a set of downlink BWPs for the UE, each downlink BWP in the set of downlink BWPs being associated with a different SCS, means for receiving second information that identifies a set of LP-WUS configurations for the UE, each LP-WUS configuration in the set of LP-WUS configurations identifying LP-WUS monitoring occasions for the UE to monitor for an LP-WUS, where an SCS of the LP-WUS includes a same SCS as an active downlink BWP from the set of downlink BWPs, and means for monitoring the LP-WUS monitoring occasions according to one or more of the set of LP-WUS configurations and a configuration of the active downlink BWP.

A non-transitory computer-readable medium storing code for wireless communications is described. The code may include instructions executable by one or more processors to receive first information that configures a set of downlink BWPs for the UE, each downlink BWP in the set of downlink BWPs being associated with a different SCS, receive second information that identifies a set of LP-WUS configurations for the UE, each LP-WUS configuration in the set of LP-WUS configurations identifying LP-WUS monitoring occasions for the UE to monitor for an LP-WUS, where an SCS of the LP-WUS includes a same SCS as an active downlink BWP from the set of downlink BWPs, and monitor the LP-WUS monitoring occasions according to one or more of the set of LP-WUS configurations and a configuration of the active downlink BWP.

Some examples of the method, user equipment (UEs), and non-transitory computer-readable medium described herein may further include operations, features, means, or instructions for performing an active BWP switch from a first downlink BWP having a first SCS to a second downlink BWP having a second SCS, where the first downlink BWP and the second downlink BWP may be included in the set of multiple downlink BWPs and switching from monitoring for the LP-WUS using the first SCS to monitoring for the LP-WUS using the second SCS.

Some examples of the method, user equipment (UEs), and non-transitory computer-readable medium described herein may further include operations, features, means, or instructions for performing an active BWP switch from the first downlink BWP configuration having the same SCS as the SCS of the LP-WUS of the single LP-WUS configuration to a second downlink BWP configuration having a different SCS and switching from monitoring for the single LP-WUS to not monitoring for the single LP-WUS based at least in part on occurrence of the active BWP switch.

In some examples of the method, to not monitor for the LP-WUS, user equipment (UEs), and non-transitory computer-readable medium described herein may further include operations, features, means, or instructions for switching to a connected mode discontinuous reception (C-DRX) operation mode.

### BRIEF DESCRIPTION OF THE DRAWINGS

FIG. 1 shows an example of a wireless communication system.

FIG. 2 shows an example of a signaling diagram that supports low power-wakeup signal (LP-WUS) subcarrier spacing (SCS) and active downlink bandwidth part (BWP) alignment.

FIG. 3 shows an example of a signaling diagram that supports LP-WUS SCS and active downlink BWP alignment.

FIG. 4 shows an example of a signaling diagram that supports LP-WUS SCS and active downlink BWP alignment.

FIG. 5 shows a block diagram of a processing system that supports LP-WUS SCS and active downlink BWP alignment.

FIG. 6 shows a diagram of a system including a device that supports LP-WUS SCS and active downlink BWP alignment.

FIGS. 7 and 8 show flowcharts illustrating methods that support low power-wakeup signal subcarrier spacing and active downlink bandwidth part alignment.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communication systems may use low power-wakeup signal (LP-WUS) operations to minimize power consumption for user equipment (UE). The UE may be signaled with LP-WUS configurations that utilize a low power-wakeup radio (LP-WUR) of the UE to monitor for LP-WUS transmissions prior to a connected mode discontinuous reception (C-DRX) ON duration. The LP-WUS detected using the LP-WUR of the UE is used to let the UE know whether to expect a physical downlink control channel (PDCCH) transmission during the ON duration. If so, the UE may power up its main radio to monitor for the PDCCH transmission during the ON duration. The UE may also be configured with one or more downlink bandwidth part (BWP) configurations that identify the BWP being used for downlink wireless communications. One downlink BWP may be active at any given time, and each BWP configuration may be associated with a subcarrier spacing (SCS). However, such wireless communications systems generally may not align the SCS of the LP-WUS being monitored by the UE with the SCS of the active downlink BWP. This approach may increase UE complexity and latency as the UE retunes to the different SCS for the active BWP.

Aspects of the subject matter described in this disclosure relate to alignment between the SCS of the LP-WUS configuration of the UE with the SCS of the active downlink BWP. For example, The UE may receive first information that configures a set of one or more downlink BWPs for the UE. In some cases, one, some or all (e.g., at least two or more) of the downlink BWP(s) in the set of downlink BWPs may be associated with a different SCS. The UE may receive second information that identifies a set of LP-WUS configurations for the UE. In some cases, one, some or all (e.g., one or more) of the LP-WUS configuration(s) in the set of LP-WUS configurations may identify LP-WUS monitoring occasions for the UE to monitor for an LP-WUS. In some aspects, an SCS of the LP-WUS may be a same SCS as an active downlink BWP from the set of downlink BWPs. Accordingly, the UE may monitor the LP-WUS monitoring occasions according to one or more of the set of LP-WUS configurations.

Particular aspects of the subject matter described in this disclosure can be implemented to realize one or more of the following potential advantages. In some examples, by aligning the SCS of the active downlink BWP with the SCS of the LP-WUS transmissions, the described techniques can be used to reduce latency associated with UE communications when operating in or from an energy savings operating mode. The SCS alignment may simplify the UE performing LP-WUS monitoring when triggered to receive PDCCH transmissions during a connected mode discontinuous reception (C-DRX) operating mode.

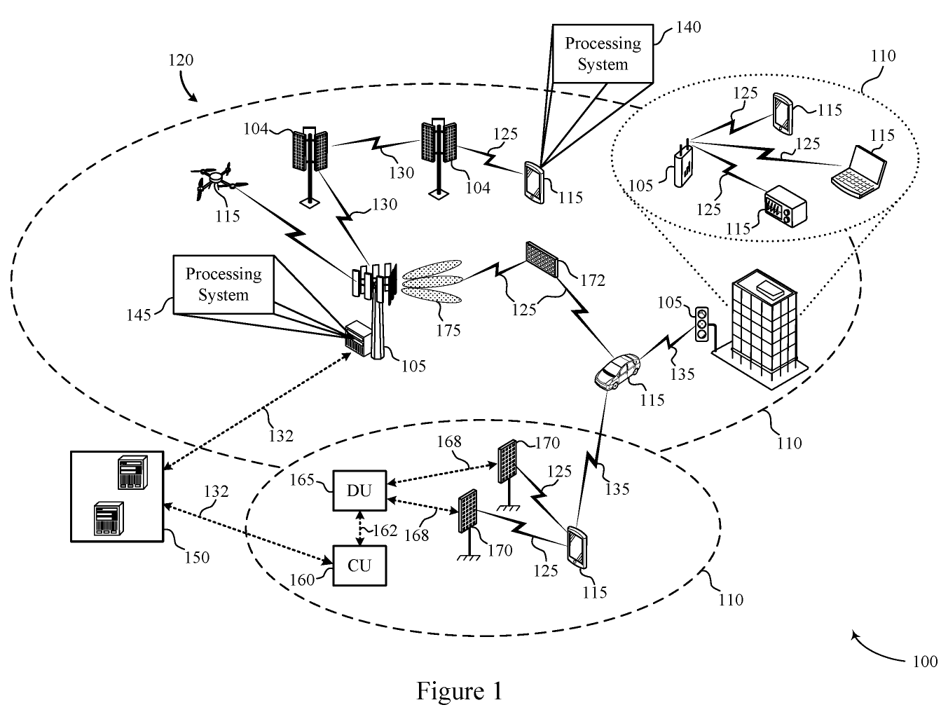

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105 and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, BWPs, or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration) or may be configured to carry both downlink and uplink communication (such as in a time division duplexing (TDD) configuration, in a sub-band full duplex (SBFD) configuration). One or more numerologies for a carrier may be supported, each associated with an SCS and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for low power-wakeup signal subcarrier spacing and active downlink bandwidth part alignment. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support improved UE energy saving operations and reduced latency by aligning the SCS of the active downlink BWP with the SCS of the LP-WUS configuration.

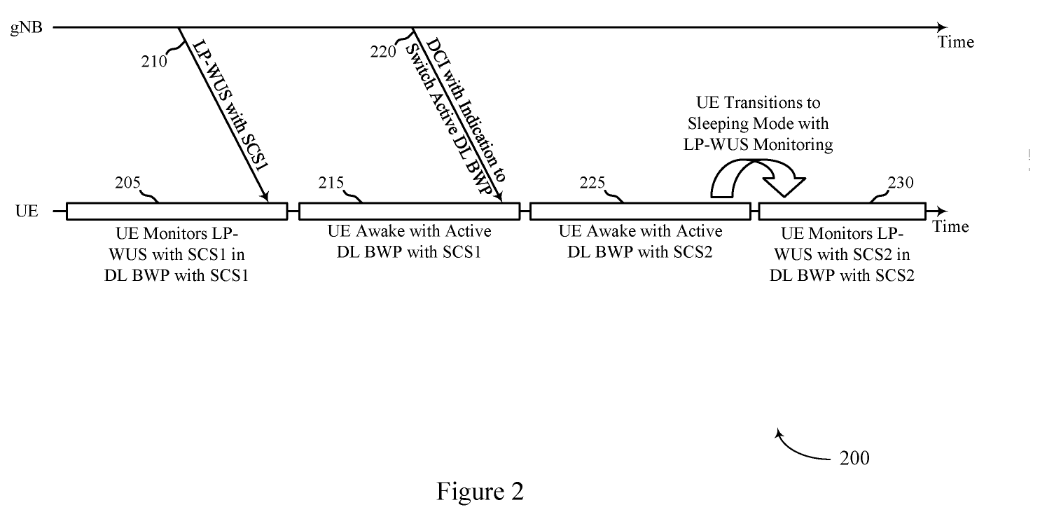

FIG. 2 shows an example of a signaling diagram 200 that supports LP-WUS SCS and active downlink BWP alignment. Aspects of the signaling diagram 200 may be implemented by and/or may implement aspects of the wireless communication system 100. For example, aspects of the signaling diagram 200 may be implemented by and/or may be implemented at a UE and/or a network entity (e.g., a gNB), which may be examples of the corresponding devices described herein.

Wireless networks may configure LP-WUS triggered PDCCH monitoring via a C-DRX configuration as a power saving procedure for RRC connected mode UE. For the LP-WUS triggered PDCCH monitoring, the UE may be equipped with a new type of receiver (e.g., a LP-WUR) in addition to the current receiver UE uses (e.g., its Main Receiver/Radio (MR)). The LP-WUR may be switched on and off quickly and may be capable of receiving and processing simple signals (e.g., limited bandwidth and simpler waveform). The LP-WUR may use significantly less power to operate than the main radio but LP-WUR cannot transmit (e.g., the LP-WUR does not include a transmit chain). The LP-WUS may be an on-off keying (OOK) waveform and the UE may use the LP-WUR to receive LP-WUS transmission from the network.

In some aspects, the LP-WUS triggered PDCCH monitoring may include the UE switching off its main radio to save power (e.g., while the UE is in a deep sleep mode). With the UE’s main radio switched off, the UE may use the LP-WUR to monitor for LP-WUS transmissions. If the network transmits an LP-WUS and UE receives the LP-WUS, the UE may wake up (e.g., switches on) its main radio to receive a control message (e.g., a DCI) from the network (e.g., the LP-WUS triggered PDCCH monitoring) using its main radio.

Some wireless networks may support OOK-1 and/or OOK-4 as the supported formats for the LP-WUS and/or the low power-synchronization signal (LP-SS) transmissions. The OOK-1 format includes conveying one bit of information in one OFDM symbol (e.g., using the amplitude of the OOK-1 waveform). The OOK-4 format includes conveying M bits of information in one OFDM symbol (e.g., using the amplitude of the OOK-4 waveform). Thus, in the baseband the OOK waveform is a sequence of high power/amplitude (or ON) durations or low (or zero) power/amplitude (or OFF) durations. One configuration of the LP-WUS may include 11 physical resource blocks (PRBs) for an LP-WUS with an SCS of 30KHz (for FR1, TBD for FR2). Thus, the high/low durations of the OOK waveforms are used to convey information (e.g., bits). An overlaid OFDM sequence may include Gold sequences, M sequences, computer searched sequences, or Zadoff-Chu sequences.

In some wireless networks, a C-DRX configuration may provide for a UE power saving procedure in which the UE periodically wakes up to monitor the PDCCH for the control message from the network. Periods when the UE wakes up to monitor PDCCH for the control msg from network is called C-DRX active time (e.g., the ON durations). When the UE is not in the active time (e.g., OFF duration), the UE may be allowed to go into a sleep mode to conserve power. One disadvantage of the C-DRX operations is that when the UE is not in the active time (i.e., during OFF durations), the network cannot transmit control messages to the UE, which results in increased latency. Some wireless networks may utilize the LP-WUS operations to address such a disadvantage related to the C-DRX operations.

Some wireless networks may also use downlink BWP configurations for the UE. The UE may be configured with up to four RRC-configured carrier downlink BWPs. For each serving cell of the UE, the network may configure at least one downlink BWP (e.g., the initial DL BWP). The bandwidth of each BWP may be equal to or greater than the synchronization signal block (SSB) bandwidth, but it may or may not contain the SSB. In some aspects, only one carrier BWP may be active at a given time. The UE may not be expected to receive physical downlink shared channel (PDSCH), PDCCH, channel state information-reference signal (CSI-RS), or tracking reference signal (TRS) transmissions outside of the active BWP. Each downlink BWP may include at least one control resource set (CORESET) with a UE specific search space (USS). In primary carrier, at least one of the configured downlink BWPs may include one CORESET with a common search space (CSS). The downlink BWP may have different types (e.g., initial, first active, or regular). The initial downlink BWP may be used during a random access procedure. The first active downlink BWP may be used during a connection (re)establishment procedure. In some cases, the UE may be configured with a BWP inactivity timer. Upon expiration of the BWP inactivity timer, the UE may be configured to switch to a downlink BWP that has been designated as default BWP.

In some cases, the downlink BWP configurations may be divided into common and dedicated parameters. The BWP-common parameters are cell specific and may include a frequency domain location, a bandwidth, an SCS, and a cyclic prefix. The BWP-common parameters may include additional cell-specific parameters for the PDCCH and/or the PDSCH of this downlink BWP. The BWP-dedicated parameters are UE specific and may include UE-specific parameters for the PDCCH, the PDSCH, and/or for semi-persistent scheduling. The BWP-dedicated parameters may include a radio link monitoring configurations of this downlink BWP. The downlink BWP may be switched (e.g., from a one downlink BWP to another downlink BWP) based on a DCI having a DCI format of 1_1 or 0_1. The UE may complete the switching of the active downlink and/or uplink BWP within a required BWP switch delay. In some cases, the switch delay may be denoted by a TBWPswitchDelay information element (IE) for DCI-based BWP switching and may be defined as the slot offset between the downlink slot in which the UE received the switch request and the first slot in which the UE shall be able to receive PDSCH in the new BWP. If the BWP switch happens between BWPs of different SCS values, the switch delay requirement may be determined by the smaller SCS.

In some cases, the downlink BWP can be switched based on timer. The network may configure a UE with a BWP inactivity timer and a default downlink BWP on a serving cell. The default downlink BWP may be one of the downlink BWPs configured for the UE and may become the active downlink BWP upon expiration of the inactivity timer. If no default downlink BWP is configured, the default downlink BWP may be the initial downlink BWP. The UE may start the BWP inactivity timer of a serving cell, if configured, when it activates a downlink BWP other than the default downlink BWP. The UE may restart the BWP inactivity timer of the serving cell when it decodes a DCI with a downlink assignment for the active downlink BWP in TDD, or when it decodes a DCI with a downlink assignment or uplink grant for its active downlink and/or uplink BWP pair in FDD. A UE may (re)start the BWP inactivity timer when a PDCCH for DCI-based BWP switching is received. The BWP inactivity timer may be started or restarted when there is no ongoing random-access procedure associated with the serving cell.

For timer-based BWP switch, the BWP switch transition time duration may be set as from the subframe/half-subframe for frequency range one (FR1)/frequency range two (FR2) immediately after a BWP inactivity timer expires until the beginning of a slot where the UE can receive or transmit. The UE may not be required to receive or transmit on the serving cell during the transition. The timer-based BWP switch may share the same BWP switch delay requirements as the DCI-based BWP switching.

However, such wireless networks generally do not provide a mechanism or otherwise support SCS alignment between the LP-WUS configuration(s) for the UE with the downlink BWP. This may result in various retuning operations by the UE when transitioning from LP-WUS monitoring to PDCCH monitoring. This may increase UE complexity as well as introduce additional delays for the wireless communications between the UE and the wireless network. As discussed, the LP-WUS may trigger PDCCH monitoring in the active downlink BWP such that, if the UE has to change the SCS between the LP-WUS reception and the PDCCH monitoring, this may introduce additional latency.

Accordingly, aspects of the techniques described herein provide for alignment between the SCS of the LP-WUS transmissions and the active downlink BWP. The described techniques may support the UE performing BWP switching (e.g., switching the active BWP) where the configured BWPs have different SCSs. In some aspects, this may include the UE operating in an RRC connected mode or state and being configured with LP-WUS monitoring where the LP-WUS SCS is the same as the active downlink BWP SCS. In some aspects for the RRC connected mode UE, the LP-WUS frequency resources may be outside of the active downlink BWP but may be within the same carrier as the active downlink BWP. In this case, the basic capability of the UE may support LP-WUS monitoring, when configured, where the frequency resources are within active downlink BWP. The UE monitoring the LP-WUS frequency resource outside of the active downlink BWP may be subject to a separate UE capability.

For example, the UE may receive or otherwise obtain (and the network entity may transmit or otherwise output) first information that configures a set of downlink BWPs for the UE. In some aspects, each, some, or all of the downlink BWPs configured for the UE may be associated with a different SCS. That is, the downlink BWPs that the network configures for the UE may include downlink BWPs having different SCSs. In some aspects, this may include downlink BWPs in different FRs, in different frequency bands, and the like. In some aspects, the UE may be configured with the first information via RRC signaling, medium access control-control element (MAC-CE) signaling, downlink control information (DCI) signaling, or any other signaling means from the network. In some aspects, the UE may be preconfigured with the first information. In some aspects, only one of the downlink BWPs configured for the UE may be active at any given time.

The UE may also receive or otherwise obtain (and the network entity may transmit or otherwise output) second information that carries or otherwise conveys information identifying a set of LP-WUS configurations for the UE. In some aspects, each, some, or all of the LP-WUS configurations in the set of LP-WUS configurations may identify LP-WUS monitoring occasions (e.g., time resources, frequency resources, spatial resources, and/or code resources) for the UE to monitor for LP-WUS transmission(s). In some aspects, an SCS of the LP-WUS may be the same SCS as an active downlink BWP from the set of downlink BWPs. That is, the PDCCH monitoring that is triggered by an LP-WUS may be performed in the active downlink BWP, where the active downlink BWP has the same SCS as the SCS associated with the LP-WUS.

Accordingly, the UE may monitor the LP-WUS monitoring occasion(s) for LP-WUS transmissions according to at least one of the LP-WUS configuration from the set of LP-WUS configurations. For example, during a time period 205 the UE may monitor for LP-WUS transmissions associated with a first SCS (e.g., SCS1) in the active downlink (DL) BWP that is also associated with the first SCS (e.g., SCS1). That is, during the time period 205 the UE may have an active downlink BWP having the first SCS and be configured for LP-WUS triggered PDCCH monitoring wherein the LP-WUS is also associated with the first SCS.

The UE may receive or otherwise obtain (and the network entity may transmit or otherwise output) an LP-WUS 210 according to the at least one LP-WUS configuration. The LP-WUS 210 may carry or otherwise convey information (e.g., a sequence of bit(s)) that triggers the UE to transition from the LP-WUS monitoring during the time period 205 into a time period 215 where the UE is in an RRC active or awake state to monitor the PDCCH in the active downlink BWP. Again, the active downlink BWP may use the first SCS (e.g., SCS1). In some cases, the network may guarantee that the LP-WUS SCS is the same as the SCS of the active downlink BWP. For example, when the UE is configured with LP-WUS monitoring for a cell, the UE may not expect an activated downlink BWP with a different SCS from the LP-WUS. In some cases, this may be based on a scheduling and/or other configuration restraint applied by the network entity. For example, when configuring and/or otherwise activating LP-WUS triggered PDCCH monitoring for the UE the network entity may ensure compliance with the scheduling and/or other configuration restraint to avoid the UE having an active downlink BWP with an SCS that is different than the SCS of the LP-WUS.

Thus, during the time period 215 the UE may monitor the PDCCH for a DCI transmission from the network entity according to the LP-WUS 210. In some aspects, the UE may perform active downlink BWP switching operations where the UE switches the active downlink BWP from a first downlink BWP to a second downlink BWP. The first and second downlink BWPs may be included in the set of downlink BWPs configured for the UE. As discussed, the active downlink BWP switching operations may be triggered by reception of a DCI that indicates the active downlink BWP switch is to be performed or may be triggered by the expiration of a BWP switching timer.

In the example shown in FIG. 2, the UE may receive or otherwise obtain (and the network entity may transmit or otherwise output) a DCI 220 that carries or otherwise conveys an indication to switch the active downlink BWP. That is, in this example, the UE may perform the active BWP switch from the first downlink BWP having the first SCS (e.g., SCS1) to a second downlink BWP having a second SCS (e.g., SCS2). During a time period 225, the UE may continue to be operating in an active or awake state to perform PDCCH monitoring and/or to perform wireless communications with the network entity in the active downlink BWP (e.g., in the second downlink BWP with the second SCS). Eventually the UE may transition to the sleep mode or state (e.g., RRC idle or inactive) to again perform LP-WUS monitoring. However, the UE may switch from the first LP-WUS configuration having the first SCS to a second LP-WUS configuration that has the second SCS (e.g., SCS). During the time period 230, the UE monitor the LP-WUS monitoring occasions according to the second LP-WUS configuration for LP-WUS transmissions having the second SCS.

Thus, signaling diagram 200 illustrates an example where the set of downlink BWPs includes a plurality of downlink BWPs (e.g., at least the first and second downlink BWPs) and the set of LP-WUS configurations includes a plurality of LP-WUS configurations (e.g., the first and second LP-WUS configurations). In this example, each LP-WUS configuration in the plurality of LP-WUS configurations may have an associated SCS of a corresponding LP-WUS. That is, the SCS of the first downlink BWP may match the SCS of the first LP-WUS configuration, the SCS of the second downlink BWP may match the SCS of the second LP-WUS configuration, and so on. That is, in some aspects the associated SCS of each LP-WUS configurations may also be associated with the same SCS of at least one of the plurality of downlink BWPs.

In this example, the UE may be configured with multiple downlink BWPs with different SCSs and is also configured with multiple LP-WUS configurations with different SCSs. When a downlink BWP with SCS1 is active, the LP-WUS configuration with SCS1 is used/monitored. When a downlink BWP with SCS2 is active, the LP-WUS configuration with SCS2 is used/monitored. In some aspects, the active BWP switch (e.g., either DCI and/or MAC-timer based) for BWP switching may implicitly switch the LP-WUS configuration for the UE to monitor. That is, the UE may switch from the first LP-WUS configuration with SCS1 to the second LP-WUS configuration with SCS2 based on receipt of the DCI 220 that triggers the downlink BWP switch from the first downlink BWP having the first SCS to the second downlink BWP having the second SCS.

In some aspects, this may be based on the UE supporting both LP-WUS monitoring with SCS1 and LP-WUS monitoring with SCS2. This support may be reported to the network as part of UE capability signaling. For example, the UE may transmit or otherwise output (and the network entity may receive or otherwise obtain) a UE capability message that indicates support for the plurality of LP-WUS configurations having different SCSs.

In some aspects, the network may configure both the first LP-WUS with SCS1 and the second LP-WUS with SCS2 to the UE (e.g., in the plurality of LP-WUS configurations), such as via RRC signaling and/or other signaling means. In some aspects, there may be a timeline associated with BWP switching (e.g., the time it takes the UE to retune and/or perform other operations or functions that support changing the active downlink BWP from SCS1 to SCS2). Accordingly, there may also be a timeline during which the UE switches from the first LP-WUS configuration having SCS1 to the second LP-WUS configuration having SCS2. In some cases (e.g., for DCI-based downlink BWP switching), the LP-WUS switching timeline may follow the BWP switching timeline. In some cases (e.g., for MAC-timer based downlink BWP switching), the LP-WUS switching timeline may be defined (e.g., such as 3ms after the BWP switching timer has expired).

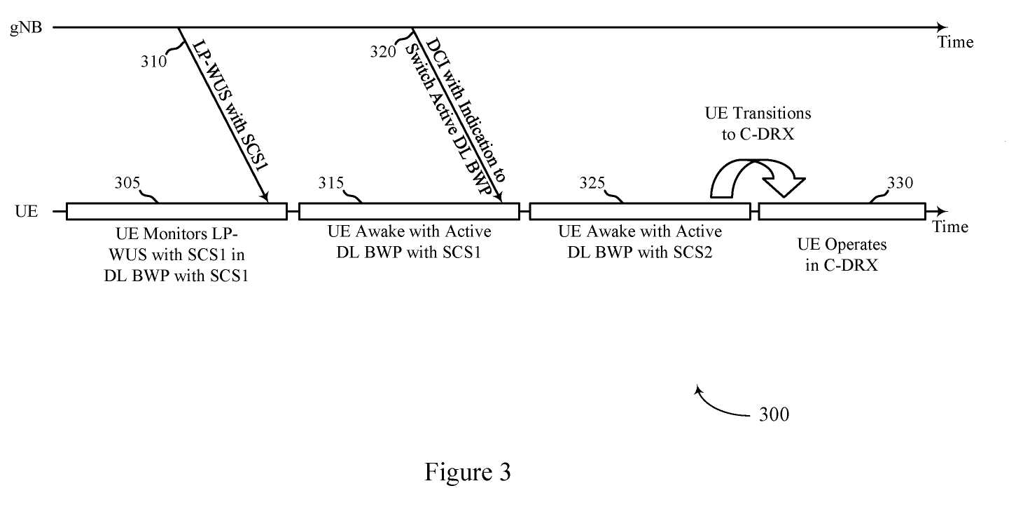

FIG. 3 shows an example of a signaling diagram 300 that supports LP-WUS SCS and active downlink BWP alignment. Aspects of the signaling diagram 300 may be implemented by and/or may implement aspects of the wireless communication system 100. For example, aspects of the signaling diagram 300 may be implemented by and/or may be implemented at a UE and/or a network entity (e.g., a gNB), which may be examples of the corresponding devices described herein.

Aspects of the techniques described herein provide for alignment between the SCS of the LP-WUS transmissions and the active downlink BWP. The described techniques may support the UE performing BWP switching (e.g., switching the active BWP) where the configured BWPs have different SCSs. In some aspects, this may include the UE operating in an RRC connected mode or state and being configured with LP-WUS monitoring where the LP-WUS SCS is the same as the active downlink BWP SCS. For example, the UE may receive or otherwise obtain (and the network entity may transmit or otherwise output) first information that configures a set of downlink BWPs for the UE. In some aspects, the UE may be preconfigured with the first information. In some aspects, one, some, or all of the downlink BWPs configured for the UE may be associated with a different SCS. That is, the downlink BWPs that the network configures for the UE may include downlink BWPs having different SCSs. In some aspects, this may include downlink BWPs in different FRs, in different frequency bands, and the like. In some aspects, the UE may be configured with the first information via RRC signaling, MAC-CE signaling, DCI signaling, or any other signaling means from the network. In some aspects, only one of the downlink BWPs configured for the UE may be active at any given time.

The UE may also receive or otherwise obtain (and the network entity may transmit or otherwise output) second information that carries or otherwise conveys information identifying a set of LP-WUS configurations for the UE. In some aspects, each, some, or all of the LP-WUS configurations in the set of LP-WUS configurations may identify LP-WUS monitoring occasions (e.g., time resources, frequency resources, spatial resources, and/or code resources) for the UE to monitor for LP-WUS transmission(s). In some aspects, an SCS of the LP-WUS may be the same SCS as an active downlink BWP from the set of downlink BWPs. That is, the PDCCH monitoring that is triggered by an LP-WUS may be performed in the active downlink BWP, where the active downlink BWP has the same SCS as the SCS associated with the LP-WUS.

Accordingly, the UE may monitor the LP-WUS monitoring occasion(s) for LP-WUS transmissions according to at least one of the LP-WUS configuration from the set of LP-WUS configurations. For example, during a time period 305 the UE may monitor for LP-WUS transmissions associated with a first SCS (e.g., SCS1) in the active downlink BWP that is also associated with the first SCS (e.g., SCS1). That is, during the time period 305 the UE may have an active downlink BWP having the first SCS and be configured for LP-WUS triggered PDCCH monitoring wherein the LP-WUS is also associated with the first SCS.

The UE may receive or otherwise obtain (and the network entity may transmit or otherwise output) an LP-WUS 310 according to the at least one LP-WUS configuration. The LP-WUS 310 may carry or otherwise convey information (e.g., a sequence of bit(s)) that triggers the UE to transition from the LP-WUS monitoring during the time period 305 into a time period 315 where the UE is in an RRC active or awake state to monitor the PDCCH in the active downlink BWP. Again, the active downlink BWP may use the first SCS (e.g., SCS1).

Thus, during the time period 315 the UE may monitor the PDCCH for a DCI transmission from the network entity according to the LP-WUS 310. In some aspects, the UE may perform active downlink BWP switching operations where the UE switches the active downlink BWP from a first downlink BWP to a second downlink BWP. The first and second downlink BWPs may be included in the set of downlink BWPs configured for the UE. As discussed, the active downlink BWP switching operations may be triggered by reception of a DCI that indicates the active downlink BWP switch is to be performed or may be triggered by the expiration of a BWP switching timer.

In the example shown in FIG. 3, the UE may receive or otherwise obtain (and the network entity may transmit or otherwise output) a DCI 320 that carries or otherwise conveys an indication to switch the active downlink BWP. That is, in this example, the UE may perform the active BWP switch from the first downlink BWP having the first SCS (e.g., SCS1) to a second downlink BWP having a second SCS (e.g., SCS2). During a time period 325, the UE may continue to be operating in an active or awake state to perform PDCCH monitoring and/or to perform wireless communications with the network entity in the active downlink BWP (e.g., in the second downlink BWP with the second SCS). Eventually the UE may transition to the sleep mode or state (e.g., RRC idle or inactive). However, in the example shown in FIG. 3 the set of downlink BWPs includes a plurality of downlink BWPs but the set of LP-WUS configurations includes a single LP-WUS configuration. As discussed, in this example the SCS of the first downlink BWP configuration is the same SCS as the SCS of the first LP-WUS configuration (e.g., the single LP-WUS configuration, in this example). This may result in a situation where, based on the performing the active downlink BWP switch from the first downlink BWP having SCS1 to the second downlink BWP having SCS2, the UE is not configured with an LP-WUS configuration having the SCS2. That is, the active BWP switch performed by the UE in response to the DCI 320 means the UE has switched from the first downlink BWP having the same SCS (e.g., SCS1) as the first LP-WUS configuration to a second downlink BWP configuration that has a different SCS (e.g., SCS2).

In this example, the UE may switch from the single LP-WUS configuration to not monitoring for the LP-WUS based on the active downlink BWP switch. That is, the UE may cease LP-WUS monitoring according to an LP-WUS configuration based on the active downlink BWP having an SCS that is different from the SCS in any LP-WUS configuration that has been configured for the UE. Instead, the UE may switch to a C-DRX operation mode without LP-WUS monitoring during a time period 330 based on the active BWP switch.

Thus, signaling diagram 300 illustrates an example where the UE is configured with multiple downlink BWPs with different SCSs and is also configured with an LP-WUS configuration with one SCS. When the downlink BWP with SCS1 is active, the LP-WUS configuration with SCS1 is used and/or monitored. When the downlink BWP with SCS2 is active, the LP-WUS configuration may not be used and/or monitored. Instead, the UE performs legacy C-DRX operations for this scenario.

In this case, the active BWP switch may implicitly serve as a trigger for the UE to enable or disable LP-WUS monitoring. That is, both DCI based and/or MAC-timer based BWP switching may implicitly enable or disable LP-WUS monitoring by the UE. In this example, the LP-WUS monitoring is enabled when the downlink BWP with SCS1 is active and is disabled when the downlink BWP with SCS2 is active.

In some aspects, this may be based on UE support for either LP-WUS monitoring with SCS1 or LP-WUS monitoring with SCS2, which may be signaled to the network as a UE capability. For example, the UE may transmit or otherwise output (and the network entity may receive or otherwise obtain) a UE capability message that indicates support for the SCS of the single LP-WUS configuration. In this case, the network may configure either the LP-WUS configuration with SCS1 or the LP-WUS configuration with SCS2 to the UE, such as via RRC signaling or any other signaling means. As discussed above, there may be a timeline associated with the UE performing an active BWP switch and/or switching between different LP-WUS configurations and/or transitioning to the C-DRX operation mode. For the DCI-based active downlink BWP switch, the LP-WUS monitoring enabled and/or disabled timeline may follow the BWP switching timeline. For the MAC-timer based active downlink BWP switch, the LP-WUS monitoring enabled and/or disabled timeline may be defined (e.g., 3ms after the timer expiration).

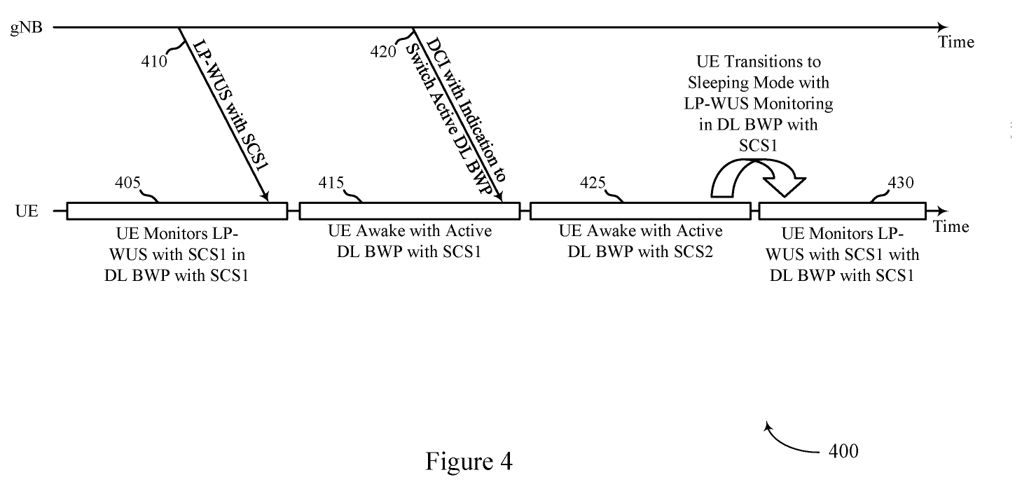

FIG. 4 shows an example of a signaling diagram 400 that supports LP-WUS SCS and active downlink BWP alignment. Aspects of the signaling diagram 400 may be implemented by and/or may implement aspects of the wireless communication system 100. For example, aspects of the signaling diagram 400 may be implemented by and/or may be implemented at a UE and/or a network entity (e.g., a gNB), which may be examples of the corresponding devices described herein.

Aspects of the techniques described herein provide for alignment between the SCS of the LP-WUS transmissions and the active downlink BWP. The described techniques may support the UE performing BWP switching (e.g., switching the active BWP) where the configured BWPs have different SCSs. In some aspects, this may include the UE operating in an RRC connected mode or state and being configured with LP-WUS monitoring where the LP-WUS SCS is the same as the active downlink BWP SCS. For example, the UE may receive or otherwise obtain (and the network entity may transmit or otherwise output) first information that configures a set of downlink BWPs for the UE. In some aspects, one, some, or all of the downlink BWPs configured for the UE may be associated with a different SCS. That is, the downlink BWPs that the network configures for the UE may include downlink BWPs having different SCSs. In some aspects, this may include downlink BWPs in different FRs, in different frequency bands, and the like. In some aspects, the UE may be configured with the first information via RRC signaling, MAC-CE signaling, DCI signaling, or any other signaling means from the network. In some aspects, only one of the downlink BWPs configured for the UE may be active at any given time.

The UE may also receive or otherwise obtain (and the network entity may transmit or otherwise output) second information that carries or otherwise conveys information identifying a set of LP-WUS configurations for the UE. In some aspects, the UE may be preconfigured with the first information. In some aspects, each, some, or all of the LP-WUS configurations in the set of LP-WUS configurations may identify LP-WUS monitoring occasions (e.g., time resources, frequency resources, spatial resources, and/or code resources) for the UE to monitor for LP-WUS transmission(s). In some aspects, an SCS of the LP-WUS may be the same SCS as an active downlink BWP from the set of downlink BWPs. That is, the PDCCH monitoring that is triggered by an LP-WUS may be performed in the active downlink BWP, where the active downlink BWP has the same SCS as the SCS associated with the LP-WUS.

Accordingly, the UE may monitor the LP-WUS monitoring occasion(s) for LP-WUS transmissions according to at least one of the LP-WUS configuration from the set of LP-WUS configurations. For example, during a time period 405 the UE may monitor for LP-WUS transmissions associated with a first SCS (e.g., SCS1) in the active downlink BWP that is also associated with the first SCS (e.g., SCS1). That is, during the time period 405 the UE may have an active downlink BWP having the first SCS and be configured for LP-WUS triggered PDCCH monitoring wherein the LP-WUS is also associated with the first SCS.

The UE may receive or otherwise obtain (and the network entity may transmit or otherwise output) an LP-WUS 410 according to the at least one LP-WUS configuration. The LP-WUS 410 may carry or otherwise convey information (e.g., a sequence of bit(s)) that triggers the UE to transition from the LP-WUS monitoring during the time period 405 into a time period 415 where the UE is in an RRC active or awake state to monitor the PDCCH in the active downlink BWP. Again, the active downlink BWP may use the first SCS (e.g., SCS1).

Thus, during the time period 415 the UE may monitor the PDCCH for a DCI transmission from the network entity according to the LP-WUS 410. In some aspects, the UE may perform active downlink BWP switching operations where the UE switches the active downlink BWP from a first downlink BWP to a second downlink BWP. The first and second downlink BWPs may be included in the set of downlink BWPs configured for the UE. As discussed, the active downlink BWP switching operations may be triggered by reception of a DCI that indicates the active downlink BWP switch is to be performed or may be triggered by the expiration of a BWP switching timer.

In the example shown in FIG. 4, the UE may receive or otherwise obtain (and the network entity may transmit or otherwise output) a DCI 420 that carries or otherwise conveys an indication to switch the active downlink BWP. That is, in this example, the UE may perform the active BWP switch from the first downlink BWP having the first SCS (e.g., SCS1) to a second downlink BWP having a second SCS (e.g., SCS2). During a time period 425, the UE may continue to be operating in an active or awake state to perform PDCCH monitoring and/or to perform wireless communications with the network entity in the active downlink BWP (e.g., in the second downlink BWP with the second SCS). Eventually the UE may transition to the sleep mode or state (e.g., RRC idle or inactive).

However, in the example shown in FIG. 4 the UE may be configured with one downlink BWP with an SCS equal to the SCS of the indicated LP-WUS configuration (e.g., SCS1, in this example). In this example, activation of LP-WUS monitoring from the network may serve as an implicit indication to switch the active downlink BWP to the first downlink BWP (e.g., the downlink BWP having the same SCS as the first LP-WUS configuration). Accordingly, in this example the UE may transition to a sleeping mode or state (e.g., RRC idle or inactive) with LP-WUS monitoring enabled. However, this may serve as the trigger for the UE to perform an active BWP switch to the first downlink BWP having the first SCS. For example, the UE may receive or otherwise obtain (and the network entity may transmit or otherwise output) a signal that triggers the LP-WUS monitoring by the UE according to the first LP-WUS configuration. The UE may perform the active BWP switch back to the first downlink BWP based on the LP-WUS monitoring trigger. Thus, during the time period 430 the UE may perform LP-WUS monitoring according to the first LP-WUS configuration having the first SCS (e.g., SCS) based on the active downlink BWP now being the first downlink BWP configuration. In some aspects of this scenario, the MAC-timer based downlink BWP switching may be suspended (e.g., the DCI-based downlink BWP switching may be enabled). In some examples, the UE entering sleep mode triggers the UE to perform the active BWP switch back to the first downlink BWP, rather than the LP-WUS monitoring triggering the switch.

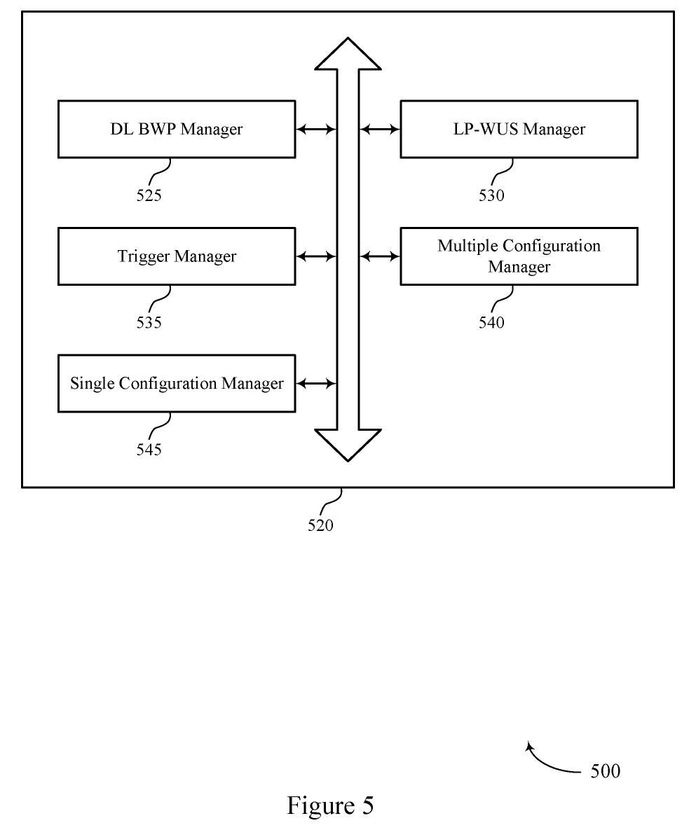

FIG. 5 shows an example 500 of a processing system 520 that supports LP-WUS SCS and active downlink BWP alignment according to the various aspects of the methods described herein. A processing system 520 may be an example of a processing system 140 (such as of a UE 115) and may include a DL BWP manager 525, an LP-WUS manager 530, a trigger manager 535, a multiple configuration manager 540, a single configuration manager 545, or any combination thereof. A processing system 520, or various component thereof, may be an example of means for performing (such as a means for causing a UE 115 to perform) various techniques described herein.

The DL BWP manager 525 may be configured to cause the UE 115 to receive first information that configures a set of downlink BWPs for the UE, each downlink BWP in the set of downlink BWPs being associated with a different SCS. Additionally or alternatively, the DL BWP manager 525 may be configured to cause the UE 115 to obtain the first information from a memory of the UE 115. The LP-WUS manager 530 may be configured to cause the UE 115 to receive second information that identifies a set of LP-WUS configurations for the UE, each LP-WUS configuration in the set of LP-WUS configurations identifying LP-WUS monitoring occasions for the UE to monitor for an LP-WUS, where an SCS of the LP-WUS includes a same SCS as an active downlink BWP from the set of downlink BWPs. In some examples, the LP-WUS manager 530 may be configured to cause the UE 115 to monitor the LP-WUS monitoring occasions according to one or more of the set of LP-WUS configurations.

In some examples, the set of downlink BWPs includes a set of multiple downlink BWPs and the set of LP-WUS configurations includes a set of multiple LP-WUS configurations. In some examples, each LP-WUS configuration in the set of multiple LP-WUS configurations has an associated SCS of a corresponding LP-WUS. In some examples, the associated SCS is also associated with the same SCS of at least one of the set of multiple downlink BWPs.

In some examples, the multiple configuration manager 540 may be configured to cause the UE 115 to transmit a UE capability message that indicates support for the set of multiple LP-WUS configurations having different SCSs.

In some examples, the multiple configuration manager 540 may be configured to cause the UE 115 to perform an active BWP switch from a first downlink BWP having a first SCS to a second downlink BWP having a second SCS, where the first downlink BWP and the second downlink BWP are included in the set of multiple downlink BWPs. In some examples, the multiple configuration manager 540 may be configured to cause the UE 115 to switch from a first LP-WUS configuration having the first SCS to a second LP-WUS configuration having the second SCS based on the active BWP switch.

In some examples, the active BWP switch is triggered by at least one of receipt of a DCI that indicates the active BWP switch is to be performed or an expiration of a BWP switching timer. In some examples, the set of downlink BWPs includes a set of multiple downlink BWPs and the set of LP-WUS configurations includes a single LP-WUS configuration. In some examples, the SCS of a first downlink BWP configuration corresponds to the same SCS as the LP-WUS of the single LP-WUS configuration.

In some examples, the single configuration manager 545 may be configured to cause the UE 115 to perform an active BWP switch from the first downlink BWP configuration having the same SCS as the SCS of the LP-WUS of the single LP-WUS configuration to a second downlink BWP configuration having a different SCS. In some examples, the single configuration manager 545 may be configured to cause the UE 115 to switch from the single LP-WUS configuration to not monitoring for the LP-WUS based on the active BWP switch.

In some examples, to support not monitoring for the LP-WUS, the single configuration manager 545 may be configured to cause the UE 115 to switch to a C-DRX operation mode based on the active BWP switch. In some examples, the active BWP switch is triggered by at least one of receipt of a DCI that indicates the active BWP switch is to be performed or an expiration of a BWP switching timer. In some examples, the single configuration manager 545 may be configured to cause the UE 115 to transmit a UE capability message that indicates support for the SCS of the single LP-WUS configuration.

In some examples, the trigger manager 535 may be configured to cause the UE 115 to receive a signal that triggers monitoring for the LP-WUS having a first SCS according to a first LP-WUS configuration of the set of LP-WUS configurations. In some examples, the trigger manager 535 may be configured to cause the UE 115 to perform an active BWP switch to a first downlink BWP configuration having the first SCS based on the signal that triggers monitoring for the LP-WUS according to the first LP-WUS configuration.

In some examples, the trigger manager 535 is configured to cause the UE 115 to perform an active BWP switch to a first downlink BWP having the first SCS based at least in part on activating monitoring for the LP-WUS according to the first LP-WUS configuration, where the activating is based on receiving a signal that triggers monitoring for the LP-WUS having the first SCS according to the first LP-WUS configuration of the set of LP-WUS configurations or on the UE 115 transitioning to sleep mode.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation in a processing system 520 as described herein, the processing system 520 may support techniques for improved LP-WUS monitoring based on aligning the SCS of the LP-WUS being monitored with the SCS of the active downlink BWP.

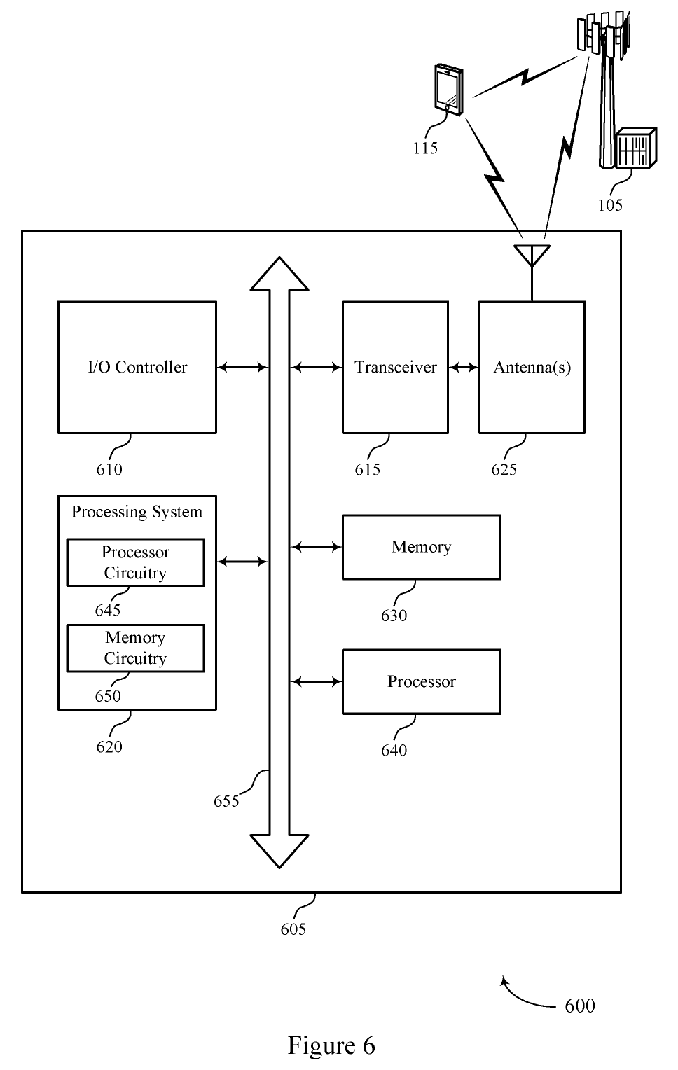

FIG. 6 shows an example of a system 600 including a device 605 that supports LP-WUS SCS and active downlink BWP alignment. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 520. For example, the processing system 620 may include processor circuitry 645 and memory circuitry 650 that stores code, and may be configured to cause the device 605 to perform operations that support low power-wakeup signal subcarrier spacing and active downlink bandwidth part alignment. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, the system 600 may support techniques for improved LP-WUS monitoring based on aligning the SCS of the LP-WUS being monitored with the SCS of the active downlink BWP according to the various aspects of the method described above.

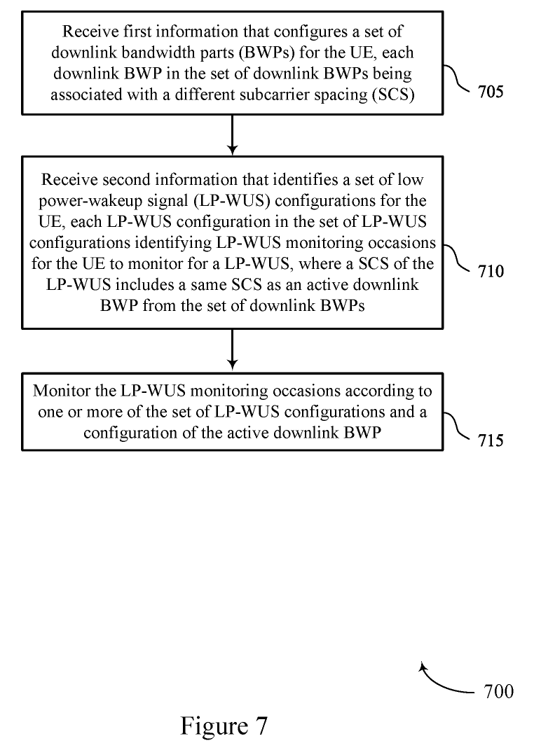

FIG. 7 shows an example of a method 700 that supports LP-WUS SCS and active downlink BWP alignment. Operations of the method 700 may be performed by a UE or its components (such as using a processing system configured to cause the UE 115 to perform one or more of the operations) as described herein.

At 705, the method may include receiving first information that configures a set of downlink BWPs for the UE, each downlink BWP in the set of downlink BWPs being associated with a different SCS. In some examples, aspects of the operations of 705 may be performed by a DL BWP manager 525.

At 710, the method may include receiving second information that identifies a set of LP-WUS configurations for the UE, each LP-WUS configuration in the set of LP-WUS configurations identifying LP-WUS monitoring occasions for the UE to monitor for an LP-WUS, where an SCS of the LP-WUS includes a same SCS as an active downlink BWP from the set of downlink BWPs. In some examples, aspects of the operations of 710 may be performed by an LP-WUS manager 530.

At 715, the method may include monitoring the LP-WUS monitoring occasions according to one or more of the set of LP-WUS configurations and a configuration of the active downlink BWP. In some examples, aspects of the operations of 715 may be performed by an LP-WUS manager 530.

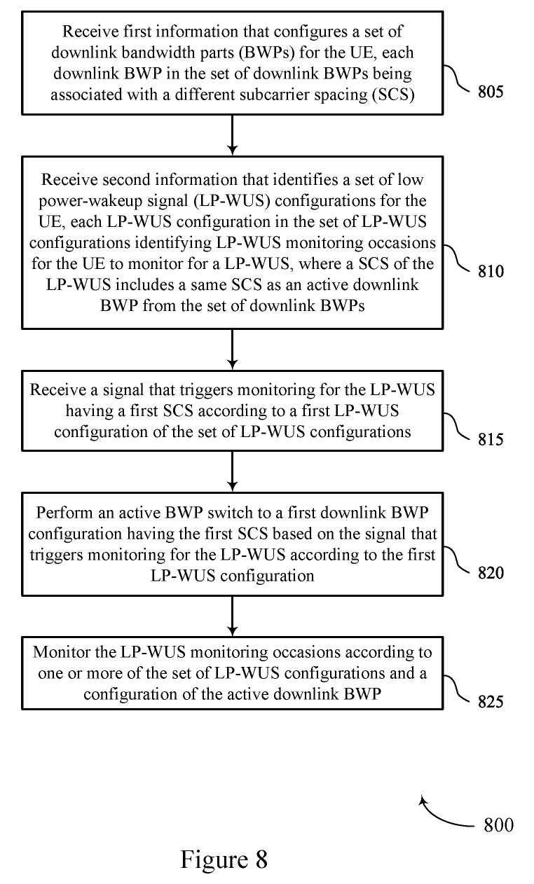

FIG. 8 shows an example of a method 800 that supports LP-WUS SCS and active downlink BWP alignment. Operations of the method 800 may be performed by a UE or its components (such as using a processing system configured to cause the UE 115 to perform one or more of the operations) as described herein.

At 805, the method may include receiving first information that configures a set of downlink BWPs for the UE, each downlink BWP in the set of downlink BWPs being associated with a different SCS. In some examples, aspects of the operations of 805 may be performed by a DL BWP manager 525.

At 810, the method may include receiving second information that identifies a set of LP-WUS configurations for the UE, each LP-WUS configuration in the set of LP-WUS configurations identifying LP-WUS monitoring occasions for the UE to monitor for an LP-WUS, where an SCS of the LP-WUS includes a same SCS as an active downlink BWP from the set of downlink BWPs. In some examples, aspects of the operations of 810 may be performed by an LP-WUS manager 530.

At 815, the method may include receiving a signal that triggers monitoring for the LP-WUS having a first SCS according to a first LP-WUS configuration of the set of LP-WUS configurations. In some examples, aspects of the operations of 815 may be performed by a trigger manager 535.

At 820, the method may include performing an active BWP switch to a first downlink BWP configuration having the first SCS based on the signal that triggers monitoring for the LP-WUS according to the first LP-WUS configuration. In some examples, aspects of the operations of 820 may be performed by a trigger manager 535.

At 825, the method may include monitoring the LP-WUS monitoring occasions according to one or more of the set of LP-WUS configurations and a configuration of the active downlink BWP. In some examples, aspects of the operations of 825 may be performed by an LP-WUS manager 530.

Implementation examples are described in the following numbered clauses:

Aspect 1: A method for wireless communications at a UE, comprising: receiving first information that configures a set of downlink BWPs for the UE, each downlink BWP in the set of downlink BWPs being associated with a different SCS; receiving second information that identifies a set of LP-WUS configurations for the UE, each LP-WUS configuration in the set of LP-WUS configurations identifying LP-WUS monitoring occasions for the UE to monitor for an LP-WUS, wherein an SCS of the LP-WUS comprises a same SCS as an active downlink BWP from the set of downlink BWPs; and monitoring the LP-WUS monitoring occasions according to one or more of the set of LP-WUS configurations and a configuration of the active downlink BWP.

Aspect 2: The method of aspect 1, further comprising: performing an active BWP switch from a first downlink BWP having a first SCS to a second downlink BWP having a second SCS, wherein the first downlink BWP and the second downlink BWP are included in the set of downlink BWPs; and switching from monitoring for the LP-WUS using the first SCS to monitoring for the LP-WUS using the second SCS.

Aspect 3: The method of aspect 1, wherein the set of downlink BWPs comprises a plurality of downlink BWPs and the set of LP-WUS configurations comprises a single LP-WUS configuration, and the SCS used to monitor for the LP-WUS corresponds to the same SCS that is used for a first downlink BWP configuration.

Aspect 4: The method of aspect 3, further comprising: performing an active BWP switch from the first downlink BWP configuration having the same SCS as the SCS of the LP-WUS of the single LP-WUS configuration to a second downlink BWP configuration having a different SCS; and switching from monitoring for the single LP-WUS to not monitoring for the LP-WUS based at least in part on occurrence of the active BWP switch.

Aspect 5: The method of aspect 4, wherein not monitoring for the LP-WUS comprises: switching to a connected mode discontinuous reception (C-DRX) operation mode.

Aspect 6: The method of any of aspects 4 through 5, wherein the active BWP switch is triggered by at least one of receipt of a DCI that indicates the active BWP switch is to be performed or an expiration of a BWP switching timer.

Aspect 7: The method of any of aspects 4 through 6, further comprising: transmitting a UE capability message that indicates support for the SCS of the single LP-WUS configuration.

Aspect 8: The method of aspect 1, further comprising: transmitting a UE capability message that indicates support for the SCS of the single LP-WUS configuration.

Aspect 9: The method of aspect 1, wherein the set of downlink BWPs comprises a plurality of downlink BWPs and the set of LP-WUS configurations comprises a plurality of LP-WUS configurations, each LP-WUS configuration in the plurality of LP-WUS configurations has an associated SCS of a corresponding LP-WUS configuration, and the associated SCS is also associated with the same SCS of at least one of the plurality of downlink BWPs.

Aspect 10: A UE for wireless communications, comprising a processing system that includes processor circuitry and memory circuitry that stores code, the processing system configured to cause the UE to perform a method of any of aspects 1through 9.

Aspect 11: A UE for wireless communications, comprising at least one means for performing a method of any of aspects 1through 9.

Aspect 12: A non-transitory computer-readable medium storing code for wireless communications, the code comprising instructions executable by one or more processors to perform a method of any of aspects 1through 9.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive first information that configures a set of downlink bandwidth parts (BWPs) for the UE, each downlink BWP in the set of downlink BWPs being associated with a different subcarrier spacing (SCS);
receive second information that identifies a set of low power-wakeup signal (LP-WUS) configurations for the UE, each LP-WUS configuration in the set of LP-WUS configurations identifying LP-WUS monitoring occasions for the UE to monitor for an LP-WUS, wherein an SCS of the LP-WUS comprises a same SCS as an active downlink BWP from the set of downlink BWPs; and
monitor the LP-WUS monitoring occasions according to one or more of the set of LP-WUS configurations and a configuration of the active downlink BWP.

2. The UE of claim 1, wherein the processing system is further configured to cause the UE to:
perform an active BWP switch from a first downlink BWP having a first SCS to a second downlink BWP having a second SCS, wherein the first downlink BWP and the second downlink BWP are included in the set of downlink BWPs; and
switch from monitoring for the LP-WUS using the first SCS to monitoring for the LP-WUS using the second SCS.

3. The UE of claim 1, wherein:
the set of downlink BWPs comprises a plurality of downlink BWPs and the set of LP-WUS configurations comprises a single LP-WUS configuration, and
the SCS used to monitor for the LP-WUS corresponds to the same SCS that is used for a first downlink BWP, wherein the first downlink BWP is included in the set of downlink BWPs.

4. The UE of claim 3, wherein the processing system is further configured to cause the UE to:
perform an active BWP switch from the first downlink BWP having the same SCS as the SCS of the LP-WUS of the single LP-WUS configuration to a second downlink BWP having a different SCS; and
switch from monitoring for the single LP-WUS to not monitoring for the single LP-WUS based at least in part on occurrence of the active BWP switch.

5. The UE of claim 4, wherein, to not monitor for the LP-WUS, the processing system is configured to cause the UE to:
switch to a connected mode discontinuous reception (C-DRX) operation mode.

6. The UE of claim 4, wherein the active BWP switch is triggered by at least one of receipt of a downlink control information (DCI) that indicates the active BWP switch is to be performed or an expiration of a BWP switching timer.

7. The UE of claim 4, wherein the processing system is further configured to cause the UE to:
transmit a UE capability message that indicates support for the SCS of the single LP-WUS configuration.

8. The UE of claim 1, wherein:
the set of downlink BWPs comprises a plurality of downlink BWPs and the set of LP-WUS configurations comprises a plurality of LP-WUS configurations;
each LP-WUS configuration in the plurality of LP-WUS configurations has an associated SCS of a corresponding LP-WUS configuration; and
the associated SCS is also associated with the same SCS of at least one of the plurality of downlink BWPs.

9. The UE of claim 1, wherein the processing system is further configured to cause the UE to:
perform an active BWP switch to a first downlink BWP having the first SCS based at least in part on activating monitoring for the LP-WUS according to the first LP-WUS configuration,
wherein the activating is based on one of: receiving a signal that triggers monitoring of the LP-WUS having the first SCS according to the first LP-WUS configuration of the set of LP-WUS configurations and the UE transitioning to sleep mode.

10. A method for wireless communications at a user equipment (UE), comprising:
receiving first information that configures a set of downlink bandwidth parts (BWPs) for the UE, each downlink BWP in the set of downlink BWPs being associated with a different subcarrier spacing (SCS);
receiving second information that identifies a set of low power-wakeup signal (LP-WUS) configurations for the UE, each LP-WUS configuration in the set of LP-WUS configurations identifying LP-WUS monitoring occasions for the UE to monitor for an LP-WUS, wherein an SCS of the LP-WUS comprises a same SCS as an active downlink BWP from the set of downlink BWPs; and
monitoring the LP-WUS monitoring occasions according to one or more of the set of LP-WUS configurations and a configuration of the active downlink BWP.

11. The method of claim 10, further comprising:
performing an active BWP switch from a first downlink BWP having a first SCS to a second downlink BWP having a second SCS, wherein the first downlink BWP and the second downlink BWP are included in the set of downlink BWPs; and
switching from monitoring for the LP-WUS using the first SCS to monitoring for the LP-WUS using the second SCS.

12. The method of claim 10, wherein:
the set of downlink BWPs comprises a plurality of downlink BWPs and the set of LP-WUS configurations comprises a single LP-WUS configuration, and
the SCS used to monitor for the LP-WUS corresponds to the same SCS that is used for a first downlink BWP, wherein the first downlink BWP is included in the plurality of downlink BWPs.

13. The method of claim 12, further comprising:
performing an active BWP switch from the first downlink BWP having the same SCS as the SCS of the LP-WUS of the single LP-WUS configuration to a second downlink BWP having a different SCS; and
switching from monitoring for the single LP-WUS to not monitoring for the single LP-WUS based at least in part on occurrence of the active BWP switch.

14. The method of claim 13, wherein not monitoring for the LP-WUS comprises:
switching to a connected mode discontinuous reception (C-DRX) operation mode.

15. The method of claim 13, wherein the active BWP switch is triggered by at least one of receipt of a downlink control information (DCI) that indicates the active BWP switch is to be performed or an expiration of a BWP switching timer.

16. The method of claim 13, further comprising:
transmitting a UE capability message that indicates support for the SCS of the single LP-WUS configuration.

17. A non-transitory computer-readable medium storing code for wireless communications, the code comprising instructions executable by one or more processors to:
receive first information that configures a set of downlink bandwidth parts (BWPs) for a user equipment (UE), each downlink BWP in the set of downlink BWPs being associated with a different subcarrier spacing (SCS);
receive second information that identifies a set of low power-wakeup signal (LP-WUS) configurations for the UE, each LP-WUS configuration in the set of LP-WUS configurations identifying LP-WUS monitoring occasions for the UE to monitor for an LP-WUS, wherein an SCS of the LP-WUS comprises a same SCS as an active downlink BWP from the set of downlink BWPs; and
monitor the LP-WUS monitoring occasions according to one or more of the set of LP-WUS configurations and a configuration of the active downlink BWP.

18. The non-transitory computer-readable medium of claim 17, the code further comprising instructions executable by the one or more processors to:
perform an active BWP switch from a first downlink BWP having a first SCS to a second downlink BWP having a second SCS, wherein the first downlink BWP and the second downlink BWP are included in the set of downlink BWPs; and
switch from monitoring for the LP-WUS using the first SCS to monitoring for the LP-WUS using the second SCS.

19. The non-transitory computer-readable medium of claim 17, wherein:
the set of downlink BWPs comprises a plurality of downlink BWPs and the set of LP-WUS configurations comprises a single LP-WUS configuration, and
the SCS used to monitor for the LP-WUS corresponds to the same SCS that is used for a first downlink BWP, wherein the first downlink BWP is included in the plurality of downlink BWPs.

20. The non-transitory computer-readable medium of claim 19, the code further comprising instructions executable by the one or more processors to:
perform an active BWP switch from the first downlink BWP having the same SCS as the SCS of the LP-WUS of the single LP-WUS configuration to a second downlink BWP having a different SCS; and
switch from monitoring for the single LP-WUS to not monitoring for the single LP-WUS based at least in part on occurrence of the active BWP switch.

21. The non-transitory computer-readable medium of claim 20, wherein, to not monitor for the LP-WUS, the code further comprises instructions executable by the one or more processors to:
switch to a connected mode discontinuous reception (C-DRX) operation mode.

22. The non-transitory computer-readable medium of claim 20, wherein the active BWP switch is triggered by at least one of receipt of a downlink control information (DCI) that indicates the active BWP switch is to be performed or an expiration of a BWP switching timer.

23. The non-transitory computer-readable medium of claim 20, wherein the code further comprises instructions executable by the one or more processors to:
transmit a UE capability message that indicates support for the SCS of the single LP-WUS configuration.

24. A user equipment (UE) for wireless communications, comprising:
means for receiving first information that configures a set of downlink bandwidth parts (BWPs) for the UE, each downlink BWP in the set of downlink BWPs being associated with a different subcarrier spacing (SCS);
means for receiving second information that identifies a set of low power-wakeup signal (LP-WUS) configurations for the UE, each LP-WUS configuration in the set of LP-WUS configurations identifying LP-WUS monitoring occasions for the UE to monitor for an LP-WUS, wherein an SCS of the LP-WUS comprises a same SCS as an active downlink BWP from the set of downlink BWPs; and
means for monitoring the LP-WUS monitoring occasions according to one or more of the set of LP-WUS configurations and a configuration of the active downlink BWP.

25. The UE of claim 24, further comprising:
means for performing an active BWP switch from a first downlink BWP having a first SCS to a second downlink BWP having a second SCS, wherein the first downlink BWP and the second downlink BWP are included in the set of downlink BWPs; and
means for switching from monitoring for the LP-WUS using the first SCS to monitoring for the LP-WUS using the second SCS.

26. The UE of claim 24, wherein:
the set of downlink BWPs comprises a plurality of downlink BWPs and the set of LP-WUS configurations comprises a single LP-WUS configuration, and
the SCS used to monitor for the LP-WUS corresponds to the same SCS that is used for a first downlink BWP, wherein the first downlink BWP is included in the plurality of downlink BWPs.

27. The UE of claim 26, further comprising:
means for performing an active BWP switch from the first downlink BWP having the same SCS as the SCS of the LP-WUS of the single LP-WUS configuration to a second downlink BWP having a different SCS; and
means for switching from monitoring for the single LP-WUS to not monitoring for the single LP-WUS based at least in part on occurrence of the active BWP switch.

28. The UE of claim 27, wherein the means for not monitoring for the LP-WUS comprise:
means for switching to a connected mode discontinuous reception (C-DRX) operation mode.

29. The UE of claim 27, wherein the active BWP switch is triggered by at least one of receipt of a downlink control information (DCI) that indicates the active BWP switch is to be performed or an expiration of a BWP switching timer.

30. The UE of claim 27, further comprising:
means for transmitting a UE capability message that indicates support for the SCS of the single LP-WUS configuration.
